(19) United States
(12) Patent Application Publication
(10) Pub. No.: US 2014/0270894 A1
(43) Pub. Date: Sep. 18, 2014

(54) COMBINATION-TYPE PEN

(71) Applicant: MAO-SUNG WU, (US)

(72) Inventors: MAO-SUNG WU, TAOYUAN (TW); Chen-Hao Chu, TAOYUAN (TW)

(73) Assignee: MAO-SUNG WU, TAOYUAN (TW)

(21) Appl. No.: 13/795,569

(22) Filed: Mar. 12, 2013

(51) Int. Cl. B43K 29/00; B43K 24/06

(52) U.S. Cl. CPC B43K 29/00; B43K 24/06
USPC 401/116; 401/99

(57) ABSTRACT

A combination-type pen includes a writing module, a touch module and a pen tube. The pen tube includes a conductive tube for containing the writing module and the touch module and first opening and second openings formed on opposite ends of the conductive tube respectively. When the writing module is protruded from the first opening and out of the pen tube, and the link rod pulls the touch portion to retract from the second opening to the pen tube, the pen is situated at a writing state. When the writing module is retracted from the first opening to the pen tube, and the link rod pushes the touch portion to protrude from the second opening and out of the pen tube, the pen is situated at a touch state. Therefore, the combination-type pen has both touch and writing functions.

### FIELD OF THE INVENTION

The present invention relates to a combination-type pen, in particular to the combination-type pen with both touch and writing functions.

### BACKGROUND OF THE INVENTION

As table PC becomes popular, fingers or touch pens are generally used as a touch interface for operating a touch device. A touch pen as disclosed in R.O.C. Utility Model Patent No. M406215 comprises a pen shaft, a conductive core, a flexible member and a fabric cover. The conductive core is coupled to an end of the pen shaft, and the flexible member is covered onto the conductive core, and the fabric cover is covered onto the flexible member. Either the flexible member or the fabric cover is electrically conductive. The flexible member and the fabric cover are compressed by the conductive core and the touch panel to deform, so that the contact area between the touch pen and the capacitive touch panel can be increased, and the fabric cover can be used for reducing the friction when the touch pen is in contact with the touch panel.

However, the conventional touch pen only has the function of touching and controlling the panel. If it is necessary to writing a note on a memo pad, the users still need a pen for writing action, not only taking some time, but also causing inconvenience to users.

### SUMMARY OF THE INVENTION

In view of the aforementioned drawbacks of the conventional pens, it is a primary objective of the present invention to provide a combination-type pen with both touch and writing functions to overcome the drawbacks of the prior art.

To achieve the aforementioned objective, the present invention provides a combination-type pen comprising a writing module, a touch module and a pen tube, wherein the touch module has a link rod and a touch portion disposed at an end of the link rod, and the pen tube includes a conductive tube for containing the writing module and the touch module, and a first opening and a second opening formed at two opposite ends of the conductive tube respectively.

When the writing portion is protruded from the first opening and out of the pen tube by rotation and linking, and the link rod pulls the touch portion to retract from the second opening to the pen tube, the combination-type pen is situated at a writing state; and when the writing portion is retracted from the first opening to the pen tube, and the link rod pushes the touch portion to protrude from the second opening and out of the pen tube, the combination-type pen is situated at a touch state. Therefore, the combination-type pen has both touch and writing functions.

Wherein, a rotating module is disposed between the writing module and the pen tube for rotating the writing module with respect to the pen tube.

Wherein, a rotating module is disposed between the touch module and the pen tube for rotating the touch module with respect to the pen tube.

Wherein, the link rod has a first snap portion, and the touch portion has a second snap portion, and the first and second snap portions are snapped and fixed with each other.

Wherein, the touch portion is made of a conductive rubber, a conductive plastic or a conductive foam.

### BRIEF DESCRIPTION OF THE DRAWINGS

FIG. 1 is a schematic view of a combination-type pen of the present invention at a writing state;

FIG. 2 is a schematic view of a combination-type pen of the present invention at a touch state;

FIG. 3 is an exploded view of a combination-type pen of the present invention;

FIG. 4 is a perspective view of a combination-type pen of the present invention;

FIG. 5 is a cross-sectional view of a combination-type pen of the present invention at a writing state;

FIG. 6 is a cross-sectional view of a combination-type pen of the present invention at a touch state;

FIG. 7 is an exploded view of a rotating module in accordance with another preferred embodiment of the present invention;

FIG. 8 is a blow-up view of a rotating module in accordance with another preferred embodiment of the present invention;

FIG. 9 is an exploded view of a rotating module in accordance with a further preferred embodiment of the present invention;

FIG. 10 is another schematic view of a combination-type pen of the present invention at a touch state; and

FIG. 11 is another schematic view of a combination-type pen of the present invention at a writing state.

### DESCRIPTION OF THE PREFERRED EMBODIMENTS

The present invention will become clearer in light of the following detailed description of an illustrative embodiment of this invention described in connection with the drawings. It is intended that the embodiments and drawings disclosed herein are to be considered illustrative rather than restrictive.

With reference to FIG. 1 for a schematic view of a combination-type pen of the present invention, the combination-type pen 1 comprises a writing module 10, a touch module 20 and a pen tube 30. The writing module 10 has a pen shaft 11 and a writing portion 12 disposed at an end of the pen shaft 11. The touch module 20 is installed in the pen tube 30 and has a link rod 21, a touch portion 22 disposed at an end of the link rod 21, and a notch 211 formed at the other end of the link rod 21 opposite to the touch portion 22 for accommodating and fixing the pen shaft 11, and the touch portion 22 is made of a conductive rubber, a conductive plastic or a conductive foam.

The pen tube 30 has a conductive tube 31 and a first opening 32 and a second opening 33 disposed opposite to each other. The combination-type pen is an automatic rotating pen, such that when the writing portion 12 is rotated to protrude from the first opening 32 and out of the conductive tube 31, and the link rod 21 pulls the touch portion 22 to retract from the second opening 33 to the conductive tube 31, the combination-type pen 1 is situated at a writing state, so that users can use the writing portion 12 for writing.

With reference to FIG. 2, when the writing portion 12 is rotated and retracted from the first opening 32 to the conductive tube 31, and the link rod 21 pushes the touch portion 22 to protrude from the second opening 33 and out of the conductive tube 31, the combination-type pen 1 is situated at a touch state, so that users can use the touch portion 22 for touching. The present invention integrates the functions of a conventional automatic pen and a conventional touch pen and achieves both functions by using a single pen to overcome the problems of a conventional automatic pen without the touch function or a conventional touch pen without the writing function.

As to the way of rotating and linking the writing portion 12, a rotating module is installed between the writing module and the pen tube for rotating and rotatable with respect to the pen tube. In FIG. 3, the combination-type pen 1 has a rotating portion 40 and a rotating module 50, wherein the rotating portion 40 is installed in the first opening 32 and has a third opening 41 interconnected with the first opening 32, and the writing portion 12 can be moved into or out of the third opening 41, and the touch portion 22 can be moved into or out of the second opening 33.

The rotating module 50 is disposed between the pen tube 30 and the rotating portion 40 and has a guide tube 51 and a rotating shaft 52, wherein a spiral guide groove 53 and a protruding column 54 are disposed between the guide tube 51 and the rotating shaft 52, and the spiral guide groove 53 is formed on an internal wall of the guide tube 51, and the protruding column 54 is disposed on an external wall of the rotating shaft 52. The other end of the rotating shaft 52 opposite to the guide tube 51 is movably coupled to the link rod 21 by movable parts such as an inner thread 521 and an outer thread 212.

With reference to FIGS. 4 and 5 for the overall installation, the touch portion 22 is installed at an end of the link rod 21, and the link rod 21 has a first snap portion 212, and the touch portion 22 has a second snap portion 221, and the first and second snap portions 212, 221 are snapped and fixed with each other to install the touch portion 22 to an end of the link rod 21, and then the rotating shaft 52 is installed at the other end of the link rod 21 and coupled by a screwing effect between the inner thread 521 and the outer thread 21, so as to assemble the link rod 21 and the rotating shaft 52 together, and the writing module is inserted and connected into the notch 211 of the link rod by passing the pen shaft 11 through the rotating shaft 52.

An end of the guide tube 51 is sheathed and coupled to the rotating shaft 52, such that the protruding column 54 can be moved within the spiral guide groove 53, and the rotating portion 40 is sheathed and coupled to the other end of the guide tube 51 to complete a semi-finished good. Finally, the semi-finished good is sheathed and coupled into the conductive tube 31 of the pen tube.

When use, a user can rotate the rotating portion 40 as shown in FIG. 6, and the rotating module rotates the rotating portion 40 at the first opening 32 with respect to the conductive tube 31, and the guide tube 51 is rotated together with the rotating portion 40. When the rotating shaft of the protruding column is moved upwardly in the spiral guide groove, the above link rod 21 is driven to push a front end of the touch portion 22 to protrude from the second opening 33 and out of the conductive tube 31, and a rear end of the touch portion 22 is contacted with the conductive tube 31, so that users can use the touch portion 22 for touching.

Of course, the rotating portion can be rotated to switch the touch state into a writing state as shown in FIG. 5, so that the writing portion 12 is protruded from the first opening 32 and the third opening 41 and out of the conductive tube 31, and the link rod 21 pulls the touch portion 22 to retract from the second opening 33 to the conductive tube 31, so that users can use the writing portion 12 for writing.

Of course, the protruding column in the rotating module can be set on an internal wall of the guide tube, and the spiral guide groove is formed on an external wall of the rotating shaft to achieve the same link relation.

With reference to FIGS. 7 and 8 for a rotating module of another preferred embodiment of the present invention, the rotating module 50 has a guide tube 51, a rotating shaft 52 and a linear guide tube 55, wherein an end of the guide tube 51 is sheathed on the rotating portion 40, and the other end of the guide tube 51 is sheathed on the rotating shaft 52, and the linear guide tube 55 is disposed between the guide tube 51 and the rotating shaft 52, and a spiral guide groove 53 is formed on an internal wall of the guide tube 51, and a protruding column 54 is disposed on an external wall of the rotating shaft 52, and the linear guide tube 55 has a linear guide slot 56. When the rotating portion 40 is rotated, the guide tube 51 is rotated together with the rotating portion 40, and the protruding column 54 is moved within the spiral guide groove 53 through the linear guide slot 56, so that the rotating shaft 52 can be moved linearly.

With reference to FIG. 9 for a rotating module of a further preferred embodiment of the present invention, the rotating module 50 has a guide tube 51, a rotating shaft 52 and a linear guide tube 55, wherein an end of the guide tube 51 is sheathed on the rotating portion 40, and the other end of the guide tube 51 is sheathed on the rotating shaft 52, and the linear guide tube 55 is disposed between the guide tube 51 and the conductive tube 31, and the linear guide tube 55 has a linear guide slot 56, and a protruding column 311 is disposed on an internal wall of the conductive tube 31. When the rotating portion 40 is rotated, the guide tube 51 is rotated together with the rotating portion 40, and the protruding column 54 can be moved within the linear guide slot 56, so that the rotating shaft 52 can be moved linearly.

In the preferred embodiment, the rotating portion of the combination-type pen is installed in the first opening and at a position opposite to the writing portion, or the rotating portion is installed in the second opening and a position opposite to the touch portion, and the rotating module is installed between the touch module and the pen tube as shown in FIG. 10. When the rotating portion 40 at the second opening 33 is rotated with respect to the conductive tube 31 and provided for protruding the touch portion 22 from the second opening 33 and the third opening 41 and out of the conductive tube 31, and the link rod 21 pulls the writing portion 12 to retract from the first opening 32 to the conductive tube 31, the combination-type pen 1 is situated at a touch state, so that users can use the touch portion 22 for touching.

With reference to FIG. 11 for switching the touch state to a writing state, the rotating portion 40 is rotated, and the rotating module is used to retract the touch portion 22 to the conductive tube 31, and the link rod 21 pushes the writing portion 12 to protrude from the first opening 32 and out of the conductive tube 31, so that users can use the writing portion 12 for writing.

In summation of the description above, the present invention improves over the prior art, and is thus duly filed for patent application. While the invention has been described by means of specific embodiments, numerous modifications and variations could be made thereto by those skilled in the art without departing from the scope and spirit of the invention set forth in the claims.

What is claimed is:

1. A combination-type pen, comprising:
a writing module, having a writing portion;
a touch module, having a link rod and a touch portion disposed at an end of the link rod; and
a pen tube, including a conductive tube for containing the writing module and the touch module, and a first opening and a second opening formed at opposite ends of the conductive tube respectively;
thereby, when the combination-type pen including the writing portion is protruded from the first opening and out of the pen tube, and the link rod pulls the touch portion to retract from the second opening into the pen tube, the combination-type pen is situated at a writing state; and when the writing portion is retracted from the first opening into the pen tube, and the link rod pushes the touch portion to protrude from the second opening and out of the pen tube, the combination-type pen is situated at a touch state.

2. The combination-type pen of claim 1, further comprising a rotating module disposed between the writing module and the pen tube for rotating the writing module with respect to the pen tube.

3. The combination-type pen of claim 1, further comprising a rotating module installed between the touch module and the pen tube for rotating the touch module with respect to the pen tube.

4. The combination-type pen of claim 1, wherein the link rod has a first snap portion, and the touch portion has a second snap portion, and the first and second snap portions can be snapped and fixed with each other.

5. The combination-type pen of claim 1, wherein the touch portion is made of a material selected from the collection of a conductive rubber, a conductive plastic and a conductive foam.

6. A combination-type pen, comprising:
a pen tube, having a conductive tube, and a first opening and a second opening disposed opposite to each other;
a rotating portion, installed into the first opening, and having a third opening interconnected to the first opening;
a writing module, installed into the pen tube, and having a pen shaft and a writing portion disposed at an end of the pen shaft, and the writing portion being capable of moving into or out of the third opening;
a touch module, installed into the pen tube, and having a link rod and a touch portion disposed at an end of the link rod, and the other end of the link rod opposite to of the touch portion being coupled to the pen shaft, and the touch portion being capable of moving into or out of the second opening; and
a rotating module, disposed between the pen tube and the rotating portion, for rotating the rotating portion at the first opening with respect to the pen tube, and selectively protruding the writing portion or the touch portion out of the pen tube.

7. The combination-type pen of claim 6, wherein the rotating module has a guide tube and a rotating shaft, and an end of the guide tube is sheathed on the rotating portion, and the other end of the guide tube is sheathed on the rotating shaft, and a spiral guide groove and a protruding column are disposed between the guide tube and the rotating shaft, and the protruding column is movable within the spiral guide groove, and the spiral guide groove is formed on an internal wall of the guide tube, and the protruding column is disposed on an external wall of the rotating shaft.

8. The combination-type pen of claim 7, wherein the other end of the rotating shaft opposite to the guide tube is movably coupled to the link rod.

9. The combination-type pen of claim 6, wherein the rotating module has a guide tube and a rotating shaft, and an end of the guide tube is sheathed on the rotating portion, and the other end of the guide tube is sheathed on the rotating shaft, and a spiral guide groove and a protruding column are disposed between the guide tube and the rotating shaft, and the protruding column is movable within the spiral guide groove, and the protruding column is disposed on an internal wall of the guide tube, and the spiral guide groove is formed on an external wall of the rotating shaft.

10. The combination-type pen of claim 8, wherein the other end of the rotating shaft opposite to the guide tube is movably coupled to the link rod.

11. The combination-type pen of claim 6, wherein the rotating module has a guide tube, a rotating shaft and a linear guide tube, and an end of the guide tube is sheathed on the rotating portion, and the other end of the guide tube is sheathed on the rotating shaft, and the linear guide tube is disposed between the guide tube and the rotating shaft, and a spiral guide groove is formed on an internal wall of the guide tube, and a protruding column is disposed on an external wall of the rotating shaft, and the linear guide tube has a linear guide slot, and the protruding column is movable within the spiral guide groove through the linear guide slot.

12. The combination-type pen of claim 6, wherein the rotating module has a guide tube, a rotating shaft and a linear guide tube, and an end of the guide tube is sheathed on the rotating portion, and the other end of the guide tube is screwed with the rotating shaft, and the linear guide tube is disposed between the guide tube and the conductive tube, and the linear guide tube has a linear guide slot, and a protruding column is disposed on an internal wall of the conductive tube and movable within the linear guide slot.

13. The combination-type pen of claim 6, wherein the link rod has a notch formed at the other end of the touch portion for containing and fixing the pen shaft.

14. A combination-type pen, comprising:
a pen tube, having a conductive tube and a first opening and a second opening disposed opposite to each other;
a rotating portion, disposed in the second opening, and having a third opening interconnected with the second opening;
a writing module, installed into the pen tube, and having a pen shaft and a writing portion disposed at an end of the pen shaft, and the writing portion being capable of moving into or out of the first opening;
a touch module, installed into the pen tube, and having a link rod and a touch portion disposed at an end of the link rod, and the other end of the link rod opposite to the touch portion being coupled to the pen shaft, and the touch portion being capable of moving into or out of the third opening; and
a rotating module, disposed between the pen tube and the rotating portion, for rotating the rotating portion at the second opening opposite to the pen tube and selectively protruding the writing portion or the touch portion out of the pen tube.

15. The combination-type pen of claim 14, wherein the rotating module has a guide tube and a rotating shaft, and an end of the guide tube is sheathed on the rotating portion, and the other end of the guide tube is sheathed on the rotating shaft, and a spiral guide groove and a protruding column are disposed between the guide tube and the rotating shaft, and the protruding column is movable within the spiral guide groove, and the spiral guide groove is formed on an internal wall of the guide tube, and the protruding column is disposed on an external wall of the rotating shaft.

16. The combination-type pen of claim 14, wherein the rotating module has a guide tube and a rotating shaft, and an end of the guide tube is sheathed on the rotating portion, and the other end of the guide tube is sheathed on the rotating shaft, and a spiral guide groove and a protruding column are disposed between the guide tube and the rotating shaft, and the protruding column is movable within the spiral guide groove, and the protruding column is disposed on an internal wall of the guide tube, and the spiral guide groove is formed on an external wall of the rotating shaft.

17. The combination-type pen of claim 14, wherein the rotating module has a guide tube, a rotating shaft and a linear guide tube, and an end of the guide tube is sheathed on the rotating portion, and the other end of the guide tube is sheathed on the rotating shaft, and the linear guide tube is disposed between the guide tube and the rotating shaft, and a spiral guide groove is formed on an internal wall of the guide tube, and a protruding column is disposed on an external wall of the rotating shaft, and the linear guide tube has a linear guide slot, and the protruding column is movable within the spiral guide groove through the linear guide slot.

18. The combination-type pen of claim 14, wherein the rotating module has a guide tube, a rotating shaft and a linear guide tube, and an end of the guide tube is sheathed on the rotating portion, and the other end of the guide tube is screwed with the rotating shaft, and the linear guide tube is disposed between the guide tube and the conductive tube, and the linear guide tube has a linear guide slot, and a protruding column is disposed on an internal wall of the conductive tube and movable within the linear guide slot.

19. The combination-type pen of claim 14, wherein the link rod has a notch formed at the other end of the touch portion for containing and fixing the pen shaft.

20. The combination-type pen of claim 14, wherein the link rod has a first snap portion, and the touch portion has a second snap portion, and the first and second snap portions are snapped and fixed to each other.
